(19) United States
(12) Patent Application Publication
(10) Pub. No.: US 2003/0126086 A1
(43) Pub. Date: Jul. 3, 2003

(54) Methods and apparatus for digital rights management

(75) Inventor: Reem Safadi, Horsham, PA (US)

Correspondence Address: LAW OFFICE OF BARRY R LIPSITZ, 755 MAIN STREET, MONROE, CT, 06468, US

(73) Assignee: General Instrument Corporation, Horsham, PA (US)

(21) Appl. No.: 10/039,156

(22) Filed: Dec. 31, 2001

(51) Int. Cl. G06F 17/60

(52) U.S. Cl. 705/51; 709/246; 705/57

(57) ABSTRACT

Apparatus and methods are provided to allow content protected by different digital rights management schemes from a plurality of content providers to be downloaded, played and/or viewed on a single consumer device, without regard to the original DRM scheme used to protect the content. The present invention acts as a type of proxy agent or intermediary for the consumer that has requested the content. The original DRM scheme of particular content is converted to a native DRM scheme compatible with the consumer device that has requested the content before the requested content is delivered to the consumer device. A network operator (e.g., a content delivery system operator) can therefore interface with multiple content providers having disparate DRM schemes, while maintaining a consistent DRM scheme on the operator's network and the associated consumer devices.

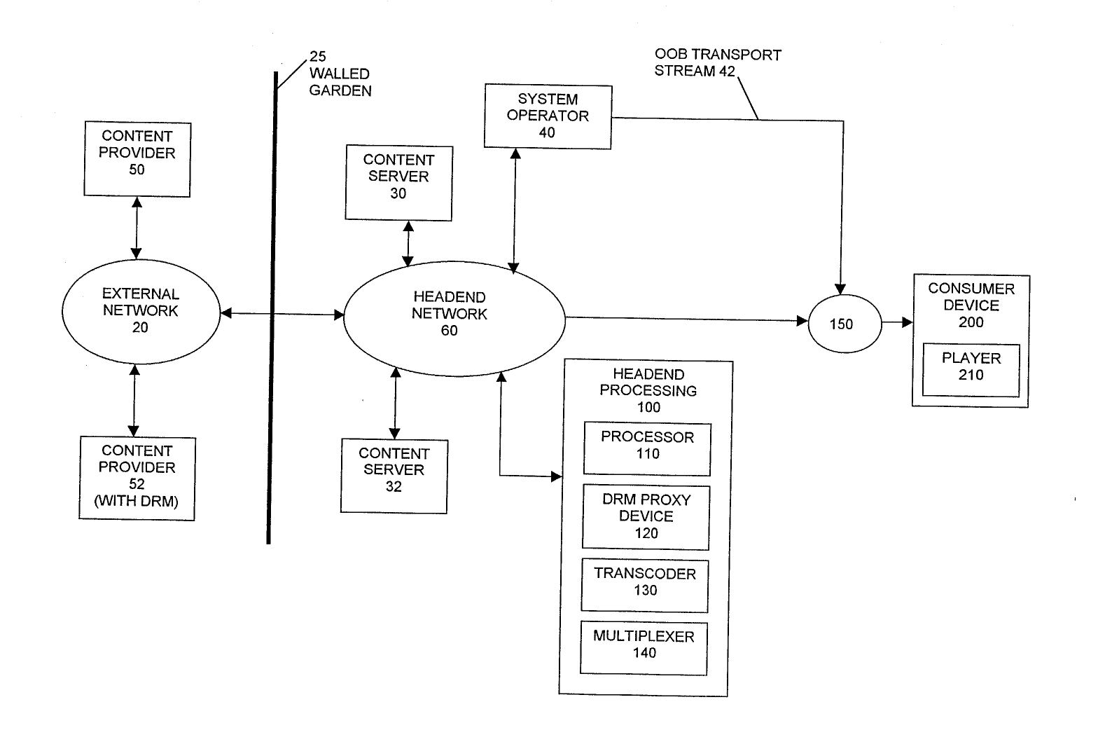

### BACKGROUND OF THE INVENTION

The present invention relates generally to the field of digital communications. More particularly, the present invention relates to digital rights management and copy protection of content provided over a digital communications network.

Digital Rights Management (DRM) secures the sale of content and protects against illegal and unauthorized distribution and playback of the content. DRM may also allow for copy control, including anti-copying features, conditional copy features, and generational copy-control features. DRM protects content owners, publishers, distributors, and retailers. DRM typically enforces encryption of content. Decryption is allowed, for example, only when the software is properly licensed, which enables the necessary decryption key(s) to be obtained. Such protection allows high quality content to be readily made available to consumers. Consumers, however, would prefer to do without DRM restrictions. As a result, a balance is necessary between securing the content and inconveniencing the consumer.

Copy protection is intended to protect digital content from being illegally copied and distributed. This may be done at two levels by: (1) preventing illegal copying and controlling how many copies are made; (2) preventing access to transferred bits and preventing theft of content while bits are being transferred.

The steps involved in a typical DRM system consist of the following:

a) digital content is created;

b) the content is sealed (encrypted);

c) the content is hosted by the seller and/or distributor (if not the same);

d) the user acquires the sealed content and permissions (e.g., license, decryption key);

e) the content is unsealed and used.

Typically, DRM schemes allow authorized users to download, preview, purchase and play or view the content. Associated access rights may have time based expiration of content usage or limit the number of plays. Content usage rules include price, payment offer, play, view, print, copy, save, super-distribution, and the like. When DRM is coupled with copy protection, the following becomes controllable: copy never, copy once, generational copy control, unlimited copy, and the like. Generational copy control refers to the governing of making copies from copies. For example, generational copy control may be implemented such that only a certain number of copies may be made from an original or subsequent copy of the original. In addition, copy control features may be added or updated to the copy and/or the original each time a copy is made, so that: (1) the copy is provided with new copy control features, which may be the same as or different from the copy control features of the original, depending on the user's rights; and (2) the original copy protection features are updated to account for the copy or copies made.

Secure storage and binding the usage rights and decryption keys to hardware prevents casual attacks. Authentication of DRM components is typically accomplished using digital signatures and public key certificates. Encryption and decryption may use symmetric cipher and DES standards, geared towards fast processing and fault tolerance (against lost data). The decryption key may be included in the content license.

Rights language and licensing are used to express usage rights. Digital rights language may be based on Extensible Rights Markup Language (XrML) developed by ContentGuard® and once specified it is digitally signed. XrML provides a universal method for specifying rights and issuing conditions associated with the use and protection of content. XrML enables content owners to describe rights fees and conditions appropriate to the business/commerce models they select. It also provides standard easy to understand terms for usage rights. In addition, XrML offers vendors operational definitions of trusted systems for compliance testing and evaluation. It also provides extensibility to new language features.

There are currently a large number of DRM and copy protection schemes which have been or are being developed by various manufacturers. These schemes are implemented in various media players, so that a user can download, play and/or view various types of digital content, such as streaming media content, digital music files, digital video files, digital multimedia files, and digital image files. In addition, various DRM schemes have been implemented to protect the delivery of television programming, such as subscription programming, pay-per-view programming, or on-demand programming.

Due to the large number of available media players with varying DRM schemes, as well as the varying DRM schemes used in the television, music, and film industries, convergence on any specific solution will most likely not occur for years to come.

It would be advantageous to provide methods and apparatus for digital rights management that allow a user to download and use content at a single media player or consumer device regardless of the DRM scheme, as long as that user has the right to such content. It would also be advantageous if such a solution is transparent to the user and to the content provider. It would be further advantageous if such a system provides for converting the original DRM scheme initially used by the content provider to protect the content to a “native” DRM scheme associated with the consumer device or media player. It would be further advantageous to provide for such a DRM solution in an existing programming and content delivery system, such as for example, a cable or satellite network.

The methods and apparatus of the present invention provide the foregoing and other advantages.

### SUMMARY OF THE INVENTION

The present invention provides methods and apparatus for digital rights management. In particular, the present invention enables digital rights management of content from a plurality of content providers so that content protected by various DRM schemes may be downloaded, played and/or viewed from a single consumer device, without regard to the original DRM scheme used to protect the content. The present invention includes a DRM proxy device for receiving content incorporating an original DRM scheme from a content provider over a first network. A processor is provided for converting the original DRM scheme to a native DRM scheme which is compatible with a consumer device used to process the content. The content is then securely delivered to the consumer device over a second network using the native DRM scheme via the DRM proxy device. A transcoder may be provided for transcoding the content from an original format to a native format compatible with the consumer device. In the event that the original DRM scheme used for particular content is compatible with (or the same as) the DRM scheme utilized by the consumer device, conversion of that particular content may be omitted.

### BRIEF DESCRIPTION OF THE DRAWING

The present invention will hereinafter be described in conjunction with the appended drawing FIGURE, which shows a block diagram of an example implementation of the present invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

Although the present invention is described herein in connection with a content delivery system, such as a cable or satellite delivery system, those skilled in the art will appreciate that the invention is equally applicable to other non-traditional delivery networks.

The present invention provides methods and apparatus for digital rights management (DRM). In particular, the present invention enables digital rights management of content from a plurality of content providers so that content protected by various DRM schemes may be downloaded, played and/or viewed from a single consumer device, without regard to the original DRM scheme used to protect the content. The DRM proxy device of the present invention acts as a type of proxy agent or intermediary for the consumer that has requested the content. The present invention enables, for example, a network operator (such as a cable television system operator) to interface with multiple content providers having disparate DRM schemes, while maintaining a consistent DRM scheme on the operator's network and the consumer devices associated therewith. This is accomplished by converting the original DRM scheme of the content to a second “native” DRM scheme which is compatible with the consumer device that has requested the content, before delivery of the requested content to the consumer device. The present invention is particularly applicable to a content delivery system having a plurality of subscribers.

As shown in the FIGURE, the present invention includes a DRM proxy device 120 for receiving content incorporating an original DRM scheme from a content provider 52 over a first network (e.g., external network 20). Although the FIGURE shows only content provider 52 as having DRM capabilities, those skilled in the art will appreciate that there may be a multitude of content providers, each having a different DRM scheme.

A processor 110 is provided for converting the original DRM scheme to a native DRM scheme which is compatible with a consumer device 200 used to process the content. The content is then securely delivered to the consumer device 200 over a second network (e.g., headend network 60) using the native DRM scheme via the DRM proxy device 120.

Those skilled in the art will appreciate that the content may be encoded and/or compressed using a variety of schemes. Therefore, a transcoder 130 may be provided for. transcoding the content from an original format (e.g., an original compression or encoding format) to a native format compatible with the consumer device 200.

The FIGURE shows the transcoder 130, DRM proxy device 120, and processor 110 as included within the headend processing system 100. Those skilled in the art will appreciate that such a representation is functional in nature only, and that the transcoder 130, DRM proxy device 120, and processor 110 may be located at different locations in the headend as separate devices. Alternatively, the functions of the transcoder 130, DRM proxy device 120, and processor 110, as well as other headend functions, may be combined in a single device, or embodied in various combinations of hardware, software and firmware. The headend processing system 100 may also include a multiplexer 140 for providing multiplexed transport streams containing the content to the consumer device 200.

The DRM proxy device 120 receives a request made via the consumer device 200 for specific content over the second network 60 and forwards the request to the content provider over the first network 20. The DRM proxy device 120 therefore acts as an invisible intermediary between the content providers 50, 52 and the consumer device 200. The DRM proxy device 120 receives the requested content from the content provider(s) 50, 52 as if it were the consumer device 200. The DRM proxy device 120 is privy to the security parameters of the consumer device 200, and can therefore receive the content on behalf of the consumer device 200. The processor 110 can then terminate the original DRM scheme (e.g., decrypt and otherwise gain access to the content as if it had been received by the consumer device 200), and then repackage the content with the native DRM scheme for secure delivery to the consumer device 200 via the DRM proxy device 120 over the second network 60. In this way, the identity of the consumer device 200 is maintained as far as the content provider is concerned, and security and conditional access rights for each consumer device 200 in the network can remain unchanged.

Those skilled in the art will appreciate that the first network 20 may comprise, for example, an external communication network, such as the world wide web, the Internet, a national backbone network, a privately owned wide area network, or any other network to which a consumer device may be connected on a generally world wide basis. The second network 60 may comprise a system operator network, which may be, for example, a cable delivery system, a satellite delivery system, a local area network, a large area network, a national network, or other similar network where access is controlled by a system operator.

In order to convert from the original DRM scheme to the native DRM scheme, the processor 110 processes DRM data of the original DRM scheme and decrypts the content in accordance with this data. The content is then re-encrypted by the processor 110 using the native DRM scheme. The native DRM scheme may comprise any DRM scheme now known in the art or subsequently developed. Various DRM schemes are already well known, and can be found in the literature. In accordance with the present invention, the content may also be transcoded (e.g., by transcoder 130) from an original format to a native format compatible with the consumer device 200. Transcoding is also well known in the art as can be seen, for example, in U.S. Pat. No. 6,275,536 to X. Chen, et al. entitled “Implementation Architectures of a Multi-Channel MPEG Video Transcoder Using Multiple Programmable Processors.”

The content may be one of streaming media content, downloadable multimedia files, digital video or music files, digital image files, subscription programming, pay-per-view programming (e.g., web cast programming), on-demand programming, or the like.

The consumer device 200 may comprise any one of a plurality of consumer devices in the delivery system, such as an audiovisual receiver/decoder device, a cable set-top device, a satellite receiver, a digital television device, a host device, a streaming media player, a web pad, an Internet device, an MP3 player, a digital video recorder, a personal versatile recorder, a computer, a cellular telephone, a personal digital assistant, or the like.

The original and native DRM schemes may comprise at least one of copy protection, copy control, content access control, encryption of the content, decryption of the content, distribution control, and usage rights. Digital rights management may be enabled using extensible rights markup language (XrML).

In a particular embodiment, the second network 60 comprises an existing video delivery system having an associated system operator 40. The content may be offered by either the content provider(s) 50, 52 or the system operator (e.g., via content servers 30, 32) based on one of a subscription basis, a pay-per-use basis, or an on-demand basis. The DRM schemes may comprise at least one of copy protection, copy control, content access control, encryption of the content, decryption of the content, distribution control, and usage rights. Delivery of the content may be tracked by the system operator 40. Where the system operator 40 provides the content via content servers 30, 32, the DRM scheme of the content may be a native DRM scheme compatible with the consumer device 200, so that no further processing is necessary before delivering of the content to the consumer device 200.

The DRM proxy device 120 may be located at a redistribution headend facility, for example, a local television headend facility (e.g., headend processing system 100). The content is delivered via the video delivery system from the headend 100 to the consumer device 200 using the native DRM scheme. In such an embodiment, the headend 100 acts as a proxy agent on behalf of the consumer device, and passes on the request for content from the consumer device to the content provider. The headend 100, via DRM proxy device 120, then receives the requested content having an original DRM scheme and converts that original DRM scheme to a native DRM scheme compatible with the consumer device 200 transparently to the consumer device 200. The requested content is then delivered to the consumer device 200 via DRM proxy device 120 over the second network 60.

It should be appreciated that revenue distribution in the foregoing scenarios may be based on prior agreements between the parties involved (e.g., between the system operator 40 and the content providers 50, 52).

A percentage of a fee for delivery of the content may be provided from the content provider 50, 52 to the system operator. Access to the content at the consumer device 200 may be enabled via the native DRM scheme.

The content may be provided by content providers 50, 52 which are outside of the system operator's walled garden 25. The walled garden 25 provides a measure of security to the system operator 40 and the consumer devices 200 by limiting access to non-qualified sites outside the headend network 60. Only content from selected content providers 50, 52 may be accessed by the consumer device 200.

The figure shows only two content providers 50, 52 and two content servers 30, 32 for ease of explanation. Content servers 30, 32 may be part of the existing delivery system and under the control of the system operator 40. Those skilled in the art will appreciate that a multitude of content providers and content servers may be available to provide content to the consumer device.

In an alternate embodiment, the consumer device 200 may be compatible with multiple DRM schemes. In such an embodiment, the conversion between an original DRM scheme and a native DRM scheme would only take place as necessary when, for example, the consumer device 200 is not compatible with the original DRM scheme of the requested content.

In order to convert the original DRM scheme to the native DRM scheme, the processor 110 may translate a DRM syntax of the original DRM scheme, e.g., extensible rights markup language (XrML), to a native syntax of the native DRM scheme.

A media player 210 which is downloadable to the consumer device 200 may be provided that is compatible with the native DRM scheme. The media player 210 may be provided by either a content provider 50, 52 or the system operator 40.

The DRM proxy device 120 may also receive unprotected content without any DRM scheme over the first network (e.g., from content provider 50). In this instance, it would be advantageous to add DRM to the content before delivering it to the consumer device. In such an instance, the processor 110 may process the unprotected content to incorporate the native DRM scheme in order to provide DRM protected content. The DRM protected content may then be securely delivered to the consumer device 200 over the second network using the native DRM scheme.

The out-of-band (OOB) data path 42 is used to transmit a variety of information from the system operator 40 to the consumer device 200, such as security and access control information (e.g., configuration, decryption entitlements, authorization commands, and the like), system configuration information, electronic programming guide (EPG) information, and downloadable objects (e.g., media players, downloadable programs, and the like). The return path from the consumer device 200 to the system operator 40 is not shown; however, various return path technologies are well known. An example return path technology is disclosed in the Data Over Cable Service Interface Specification (DOCSIS).

The content may be delivered to the consumer device 200 via an in-band MPEG-2 transport stream, via a cable modem utilizing Data Over Cable Service Interface Specification (DOCSIS), or any other transport method compatible with the second network 60 and the consumer device 200. Although unlikely when the bandwidth is constrained on the OOB channel, the transport stream carrying the content may be combined with the OOB transport stream 42 at, for example, an RF combiner 150, prior to being delivered to the consumer device 200.

It should now be appreciated that the present invention provides advantageous methods and apparatus for digital rights management of content that allows a user to download and use content at a single media player or consumer device regardless of whether a DRM scheme initially used to protect the content is compatible with the media player or consumer device.

Although the invention has been described in connection with various illustrated embodiments, numerous modifications and adaptations may be made thereto without departing from the spirit and scope of the invention as set forth in the claims.

What is claimed is:

1. A method for digital rights management (DRM) of content from a plurality of content providers, comprising the steps of:
receiving content incorporating an original DRM scheme from a content provider over a first network;
converting said original DRM scheme to a native DRM scheme which is compatible with a consumer device used to process said content; and
securely delivering said content to said consumer device using said native DRM scheme over a second network.

2. A method in accordance with claim 1, further comprising:
transcoding said content from an original format to a native format compatible with said consumer device.

3. A method in accordance with claim 1, further comprising:
receiving a request made via the consumer device for specific content over the second network; and
forwarding the request to the content provider over the first network.

4. A method in accordance with claim 1, wherein said converting step comprises:
processing data associated with the original DRM scheme;
decrypting the content using the data; and
re-encrypting said content using said native DRM scheme.

5. A method in accordance with claim 1, wherein said content comprises one of streaming media content, downloadable multimedia files, digital video or music files, digital image files, subscription programming, pay-per-view programming, or on-demand programming.

6. A method in accordance with claim 1, wherein said consumer device comprises one of an audiovisual receiver/decoder device, a cable set-top device, a satellite receiver device, a digital television device, a host device, a streaming media player, a web pad, an Internet device, an MP3 player, a digital video recorder, a personal versatile recorder, a computer, a cellular telephone, or a personal digital assistant.

7. A method in accordance with claim 1, wherein said original and native DRM schemes comprise at least one of copy protection, copy control, content access control, encryption of said content, decryption of said content, distribution control, and usage rights.

8. A method in accordance with claim 1, wherein said digital rights management is enabled using extensible rights markup language (XrML).

9. A method in accordance with claim 1, wherein said second network comprises an existing video delivery system having an associated system operator.

10. A method in accordance with claim 9, wherein:
said content is offered by one of the content provider or the system operator based on one of a subscription basis, a pay-per-use basis, or on-demand basis.

11. A method in accordance with claim 10, wherein said original and native DRM schemes comprise at least one of copy protection, copy control, content access control, encryption of said content, decryption of said content, distribution control, and usage rights.

12. A method in accordance with claim 9, further comprising:
tracking the delivery of said content by the system operator.

13. A method in accordance with claim 9, wherein:
said content is received at a redistribution headend facility;
said original DRM scheme is converted to said native DRM scheme at said headend; and
said content is delivered via said video delivery system from said headend to said consumer device using said native DRM scheme.

14. A method in accordance with claim 13, further comprising:
providing a percentage of a fee for delivery of said content from said content provider to said system operator.

15. A method in accordance with claim 1, wherein access to said content at said consumer device is enabled via said native DRM scheme.

16. A method in accordance with claim 1, wherein said consumer device is compatible with multiple DRM schemes.

17. A method in accordance with claim 1, wherein said converting step comprises translating a DRM syntax of said original DRM scheme to a native syntax of said native DRM scheme.

18. A method in accordance with claim 1, further comprising:
downloading a media player to said consumer device, said media player being compatible with said native DRM scheme.

19. A method in accordance with claim 1, further comprising:
receiving unprotected content without an any DRM scheme over the first network;
processing the unprotected content to incorporate the native DRM scheme to provide DRM protected content; and
securely delivering the DRM protected content to the consumer device using said native DRM scheme over the second network.

20. Apparatus for digital rights management (DRM) of content from a plurality of content providers, comprising:
a DRM proxy device for receiving content incorporating an original DRM scheme from a content provider over a first network; and
a processor for converting said original DRM scheme to a native DRM scheme which is compatible with a consumer device used to process said content;
wherein said content is securely delivered to said consumer device over a second network using said native DRM scheme via said DRM proxy device.

21. Apparatus in accordance with claim 20, further comprising:
a transcoder for transcoding said content from an original format to a native format compatible with said consumer device.

22. Apparatus in accordance with claim 20, wherein:
the DRM proxy device receives a request made via the consumer device for specific content over the second network and forwards the request to the content provider over the first network.

23. Apparatus in accordance with claim 20, wherein said processor:
processes data associated with the original DRM scheme;
decrypts the content using the data; and
re-encrypts said content using said native DRM scheme.

24. Apparatus in accordance with claim 20, wherein said content comprises one of streaming media content, downloadable multimedia files, digital video or music files, digital image files, subscription programming, pay-per-view programming, or on-demand programming.

25. Apparatus in accordance with claim 20, wherein said consumer device comprises one of an audiovisual receiver/decoder device, a cable set-top device, a satellite receiver, a digital television device, a host device, a streaming media player, a web pad, an Internet device, an MP3 player, a digital video recorder, a personal versatile recorder, a computer, a cellular telephone, or a personal digital assistant.

26. Apparatus in accordance with claim 20, wherein said original and native DRM schemes comprise at least one of copy protection, copy control, content access control, encryption of said content, decryption of said content, distribution control, and usage rights.

27. Apparatus in accordance with claim 20, wherein said digital rights management is enabled using extensible rights markup language (XrML).

28. Apparatus in accordance with claim 20, wherein said second network comprises an existing video delivery system having an associated system operator.

29. Apparatus in accordance with claim 28 wherein:
said content is offered by one of the content provider or the system operator based on one of a subscription basis, a pay-per-use basis, or an on-demand basis.

30. Apparatus in accordance with claim 29, wherein said original and native DRM schemes comprise at least one of copy protection, copy control, content access control, encryption of said content, decryption of said content, distribution control, and usage rights.

31. Apparatus in accordance with claim 28, wherein:
delivery of said content is tracked by the system operator.

32. Apparatus in accordance with claim 28, wherein:
said DRM proxy device is located at a redistribution headend facility; and
said content is delivered via said video delivery system from said headend to said consumer device using said native DRM scheme.

33. Apparatus in accordance with claim 32, wherein:
a percentage of a fee for delivery of said content is provided from said content provider to said system operator.

34. Apparatus in accordance with claim 20, wherein access to said content at said consumer device is enabled via said native DRM scheme.

35. Apparatus in accordance with claim 20, wherein said consumer device is compatible with multiple DRM schemes.

36. Apparatus in accordance with claim 20, wherein said processor translates a DRM syntax of said original DRM scheme to a native syntax of said native DRM scheme.

37. Apparatus in accordance with claim 20, further comprising:
a media player downloadable to said consumer device, said media player being compatible with said native DRM scheme.

38. Apparatus in accordance with claim 20, wherein:
the DRM proxy device receives unprotected content without an any DRM scheme over the first network;
the processor processes the unprotected content to incorporate the native DRM scheme to provide DRM protected content; and
the DRM protected content is securely delivered to the consumer device over the second network using said native DRM scheme.
